(19) United States
(12) Patent Application Publication
(10) Pub. No.: US 2012/0098259 A1
(43) Pub. Date: Apr. 26, 2012

(54) GASKET FOR PIPING

(76) Inventors: Armond Sarkisian, La Crescenta, CA (US); Alfred Sarkisian, La Crescenta, CA (US); Saro Sarkisian, La Crescenta, CA (US)

(21) Appl. No.: 13/277,210

(22) Filed: Oct. 19, 2011

Related U.S. Application Data
(60) Provisional application No. 61/405,362, filed on Oct. 21, 2010.

(51) Int. Cl. F16L 21/00

(52) U.S. Cl. 285/369; 277/607

(57) ABSTRACT

The present invention includes a gasket with a chamfered opening for facilitating insertion of an object within the gasket. The chamfered opening is comprised of a radially symmetric sloping surface that radially extends from a distal edge and uniformly converges inwardly at an angle into a cavity of the gasket toward a central longitudinal axis of the gasket, forming a chamfered edge.

### CROSS-REFERENCE TO RELATED APPLICATIONS

This Application claims the benefit of priority of the co-pending U.S. Utility Provisional Patent Application No. 61/405,362, filed 21 Oct. 2010, the entire disclosure of which is expressly incorporated by reference herein.

### BACKGROUND OF THE INVENTION

1. Field of the Invention

This invention relates to gaskets and, more particularly to gaskets for joining segments of pipes, or joining segments of pipes and fittings.

2. Description of Related Art

Conventional couplers such as gaskets are well known and have been in use for a number of years. FIGS. 1A and 1B are exemplary illustrations of a typical conventional gasket 100 that is used to couple or join pipe segments 150A and 150B. As illustrated in FIG. 1A, the gasket 100 is typically molded in a cylindrical shape using a variety of methods, a non-limiting example of which may be injection-molded rubber (or any elastomeric compound, a non-limiting example of which may include NEOPRENE) having a cylindrical cavity inside that is uniformly sized to receive the two pipe segments 150A and 150B from the two open ends of the gasket 100. As illustrated by the arrow 154 in FIG. 1A, the gasket 100 is first inserted onto one of the pipe segments (e.g., segment 150B) and secured. Thereafter, the other pipe segment (e.g., segment 150A) is inserted into the other open end of the gasket 100. Accordingly, the two pipe segments must first be positioned inside the gasket 100—with each pipe segment advancing (a span of 126—FIG. 1B) inside the gasket 100 up to the medially located pipe stop 114 (FIG. 1B)—and thereafter a coupling device (whether it is a no-hub coupling disclosed in U.S. Pat. No. 5,431,458 or other couplings disclosed in U.S. Patent Application Publication No. US/2009/0302601-A1) can be positioned and secured around the gasket 100 and the pipe segments 150A and 150B. The entire disclosure of the U.S. Patent Application Publication US/2009/0302601-A1 to Sarkisyan et al. is expressly incorporated by reference herein.

As illustrated in FIG. 1B, conventional gaskets 100 are generally comprised of a smooth, substantially flat cylindrical body 102 with a height 110 and an exterior diameter 104. The gaskets 100 have a hollow interior (through-hole or cavity) 122 defined by openings 120 on either side of the gasket 100 with interior diameter 108 that uniformly extends along a longitudinal axis of the gasket 100. The gasket 100 has a flat distal rim 106.

Openings 120 have a sufficient cross-sectional span (diameter) 108 for allowing insertion of a pipe or segment thereof within the cavity 122 of the gasket 100. In general, the opening diameter 108 of the gasket 100 is smaller than the exterior diameter 152 of the pipe segment 150A and or 150B, enabling a tight fit when the pipe segments 150A and 150B are inserted inside the cavity 122 of the gasket 100. The difference in size between the diameter 108 of the opening 120 and the diameter 104 of the cylindrical body 102 of the gasket 100 defines the thickness of the gasket, which is uniform inside (the cavity) and out.

As further illustrated in FIG. 1B, conventional gaskets 100 further include the medially located pipe stop 114 that allows for the insertion of each pipe segment 150A and 150B to cover roughly half of the cavity (defined by the span 126 that extends from the flat edge or rim 106 to the pipe stop 114). In general, the pipe stop 114 is comprised of a radially extending wall with a height 116 that forms a flat ring with a substantially flat surface that radially protrudes from an inner surface of the cylindrical body 102 of the gasket 100. In addition to preventing excess insertion of a pipe segment 150A and or 150B into the cavity 122, the pipe stop 114 also functions as a “gasket” or sealant for substantially sealing the junction between two edge surfaces 156A and 156B of the respective pipe segments 150A and 150B that are adjoined inside cavity 122 of the gasket 100. That is, the edge surfaces 156A and 156B of the respective pipe segments 150A and 150B are joined and abut against the sides of the pipe stop 114.

As further illustrated in FIG. 1B, the gasket 100 further includes a plurality of radially extending protuberances 112 on the inner surface of the gasket 100, transverse the longitudinal axis of the gasket 100. In general, the radially extending protuberances 112 are positioned near the openings 120 a distance 124 away from the flat rim 106. The protuberances 112 are believed to help prevent movement of the pipe segment during installation of a pipe coupling device and the pipe segments by improving the grip of the gasket 100 with the pipe segments, and are further intended to resist fluid leaks during operation. The gasket further includes substantially flat surfaces 118 that form the interior body cavity of the cylindrical body 102 of the gasket 100.

Regrettably, most conventional gaskets 100 suffer from obvious disadvantages in that it is extremely difficult, and as a consequence, labor intensive and time consuming, to insert the pipe segments inside the gaskets 100. The very aspects of the conventional gaskets that provide proper tight fit (e.g., smaller diameter 108), stronger grip (e.g., protuberances 112), and a simple manufacturing design (a flat outer edge or rim 106) are the same aspects that make the function of inserting a pipe segment into the gasket 100 extremely difficult. It should be noted that the difficulty of installation is compounded when the pipe segments are very long and cannot be simply held in position with appropriate orientation for insertion into the gasket cavity by hand. Of course, after the difficult installation (or coupling) process of the pipe segments with the gasket 100, a coupling device (disclosed in U.S. Pat. No. 5,431,458 or in U.S. Patent Application Publication No. US/2009/0302601-A1) must then be positioned and secured around the gasket 100 and the pipe segments 150A and 150B. This task becomes much more difficult and time consuming when the pipe segments are very long as the coupling device must literally be traversed or moved along the outer surface of the elongated pipe segments to reach the adjoining point of the segments (adjoined by the gasket), be positioned on the gasket, and secured.

Accordingly, in light of the current state of the art and the drawbacks to current gaskets, a need exists for an improved gasket that would provide the same functionality (at the very least), but would have the added benefit of being easier to install and capable of speeding up installation of projects where pipes (or pipes and pipe fittings) need to be joined through the use of a coupling device and a gasket therein.

### BRIEF SUMMARY OF THE INVENTION

A non-limiting, exemplary optional aspect of the present invention provides a gasket, comprising:

a chamfered opening for facilitating insertion of a pipe within the gasket;

the chamfered opening is comprised of:

a flexible flap that extends from a distal edge of a cavity, forming a chamfered edge.

Another non-limiting, exemplary optional aspect of the present invention provides a gasket, wherein:

the flexible flap is comprised of a radially symmetric surface that radially spans and uniformly converges inwardly, sloping at an angle into the cavity, toward a central longitudinal axis of the gasket.

Yet another non-limiting, exemplary optional aspect of the present invention provides a gasket, wherein: the chamfered opening further includes a hook-formed inner bottom surface.

Still another non-limiting, exemplary optional aspect of the present invention provides a gasket, wherein:

the chamfered edge has a thicker mass at the distal edge for structural integrity that adds strength for maintaining the distal edge and the chamfered side forms for proper seal and for withstanding bending pressures during insertion of the pipe into the cavity of the gasket.

A further non-limiting, exemplary optional aspect of the present invention provides a gasket, wherein:

the chamfered edge progressively and gradually decreases in thickness ending at a tip to form a flexible lip that functions as a vane that facilitates movement and insertion of the pipe into the cavity of the gasket, but obstructs and hinders the extraction of the pipe and substantially seals liquid material from exiting the cavity.

Yet a further non-limiting, exemplary optional aspect of the present invention provides a gasket, wherein:

the chamfered edge has an inner diameter defining the opening into the cavity of the gasket, and an outer diameter with a span that is sized longer than a diameter of the pipe inserted into the cavity of the gasket.

Still a further non-limiting, exemplary optional aspect of the present invention provides a gasket, wherein:

the cavity has a diameter that decreases along the central longitudinal axis from the chamfered opening to a point within the cavity;

Another non-limiting, exemplary optional aspect of the present invention provides a gasket, further comprising:

a flange that protrudes from the distal edge.

Still another non-limiting, exemplary optional aspect of the present invention provides a gasket, wherein:

the flange extends radially, outwardly diverging away from the central longitudinal axis of the gasket.

Yet another non-limiting, exemplary optional aspect of the present invention provides a gasket, further comprising:

a flange that protrudes from another distal edge of the cavity of the gasket.

A further non-limiting, exemplary optional aspect of the present invention provides a gasket, wherein:

the flange extends radially, outwardly diverging away from the central longitudinal axis of the gasket.

Still a further non-limiting, exemplary optional aspect of the present invention provides a gasket, further comprising:

a second chamfered opening.

Another non-limiting, exemplary optional aspect of the present invention provides a gasket, further comprising:

a flange that protrudes from the distal edge.

Another non-limiting, exemplary optional aspect of the present invention provides a gasket, comprising:

a chamfered opening for facilitating insertion of a pipe within the gasket;

the chamfered opening is comprised of a radially symmetric sloping surface that radially extends from a distal edge and uniformly converges inwardly at an angle into a cavity of the gasket toward a central longitudinal axis of the gasket, forming a chamfered edge; and

a radial flange that protrudes from the distal edge and extends outwardly diverging away from the central longitudinal axis of the gasket.

Yet another non-limiting, exemplary optional aspect of the present invention provides a gasket, further comprising:

a second chamfered opening and a second radial flange at another distal edge of the cavity of the gasket.

Another non-limiting, exemplary optional aspect of the present invention provides a gasket, comprising:

first and second chamfered openings for facilitating insertion of pipes within the gasket;

the chamfered openings are comprised of a radially symmetric sloping surface that radially extends from distal edges and uniformly converges inwardly at an angle into a cavity of the gasket toward a central longitudinal axis of the gasket, forming respective first and second chamfered edges; and

first and second radial flanges that protrude from the distal edges and extend outwardly diverging away from the central longitudinal axis of the gasket.

Still another non-limiting, exemplary optional aspect of the present invention provides a gasket, comprising:

an opening and a chamfered opening for facilitating insertion of pipes within the gasket;

the chamfered opening is comprised of a radially symmetric sloping surface that radially extends from a distal edge and uniformly converges inwardly into a cavity of the gasket toward a central longitudinal axis of the gasket, forming a chamfered edge;

the cavity has a diameter that decreases along the central longitudinal axis from the opening and the chamfered opening to a point within the cavity.

A further non-limiting, exemplary optional aspect of the present invention provides a gasket, further comprising:

the opening is a second chamfered opening.

Still a further non-limiting, exemplary optional aspect of the present invention provides a gasket, comprising:

cylindrical body with a cavity;

a first chamfered opening at a first end of the cylindrical body and a second chamfered opening at a second end of the cylindrical body;

the first and the second chamfered openings are comprised of a radially symmetric sloping surface that radially extend from distal edges of the first and second end of the cylindrical body and uniformly converge inwardly into a cavity of the gasket toward a central longitudinal axis of the gasket, forming a respective first and second chamfered edge;

the cavity has a diameter that decreases along the central longitudinal axis from the first and second chamfered openings to a point within the cavity, with the exterior diameter of the cylindrical body being uniform; and

a first and a second radial flanges that protrude from the distal edges of the first and second end of the cylindrical body and extend outwardly diverging away from the central longitudinal axis of the gasket.

Another non-limiting, exemplary optional aspect of the present invention provides a gasket, comprising:

the outer surface of the cylindrical body includes one or more radially extending protuberances, transverse the longitudinal axis of the gasket, forming outer surface rings.

Still another non-limiting, exemplary optional aspect of the present invention provides a gasket, comprising:

an inner surface of the cavity includes a radially extending wall with a height that forms a flat ring with a substantially flat surface that radially protrudes from the inner surface of the cylindrical body of the gasket for preventing excess insertion of a piper into the cavity, and for providing a sealant at a junction between two distal edge surfaces of pipes inserted via the first and second chamfered openings that are adjoined inside the cavity of the gasket, with the two distal edge surfaces of pipes abutting against sides of the radially extending wall.

Yet another non-limiting, exemplary optional aspect of the present invention provides a gasket, comprising:

an inner surface of the cavity includes a plurality radially extending protuberances on the inner surface of the gasket, transverse the longitudinal axis of the gasket;

the radially extending protuberances are positioned near the first and second chamfered openings a distance away from the outer edge rim of the first and second ends for preventing movement of the pipe inserted within the cavity segment and for resisting leakage during operation.

A further non-limiting, exemplary optional aspect of the present invention provides a pipe coupling device, comprising:

a gasket that includes:

cylindrical body with a cavity;

a first chamfered opening at a first end of the cylindrical body and a second chamfered opening at a second end of the cylindrical body;

the first and the second chamfered openings are comprised of a radially symmetric sloping surface that radially extend from a distal edge of the first and second end of the cylindrical body and uniformly converge inwardly at an angle into a cavity of the gasket toward a central longitudinal axis of the gasket, forming a respective first and second chamfered edge;

the cavity has a diameter that decreases along the central longitudinal axis from the first and second chamfered openings to a point within the cavity;

a first and a second radial flanges that protrude from the distal edge of the first and second end of the cylindrical body and extend outwardly diverging away from the central longitudinal axis of the gasket; and

a pipe coupler that is secured in between the first and the second flanges.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIGS. 1A and 1B are exemplary illustrations of a typical conventional gasket that is used to couple or join pipe segments;

FIGS. 2A to 2D are non-limiting exemplary illustrations of the various views of a gasket in accordance with the present invention, with FIG. 2D illustrating a cross-sectional view of the gasket;

FIGS. 3A to 3C are non-limiting exemplary illustrations of the gasket of FIGS. 2A to 2D in combination with various coupling devices in accordance with the present invention; and

FIGS. 4A to 4C are non-limiting exemplary illustrations of the gasket of FIGS. 2A to 2D in combination with various coupling devices coupled with pipe segments in accordance with the present invention.

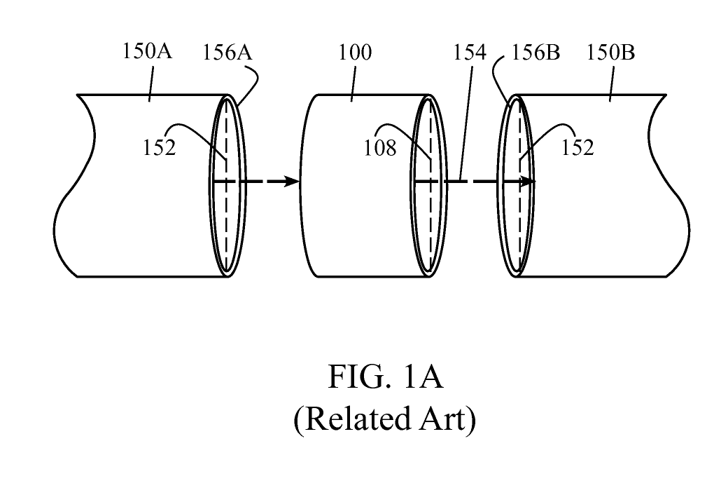

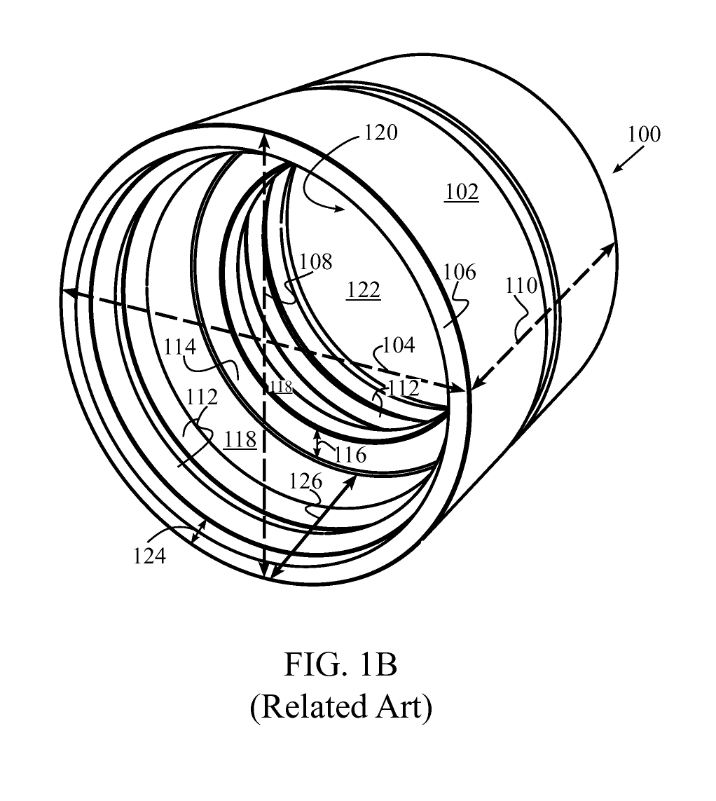

### DETAILED DESCRIPTION OF THE INVENTION

The detailed description set forth below in connection with the appended drawings is intended as a description of presently preferred embodiments of the invention and is not intended to represent the only forms in which the present invention may be constructed and/or utilized.

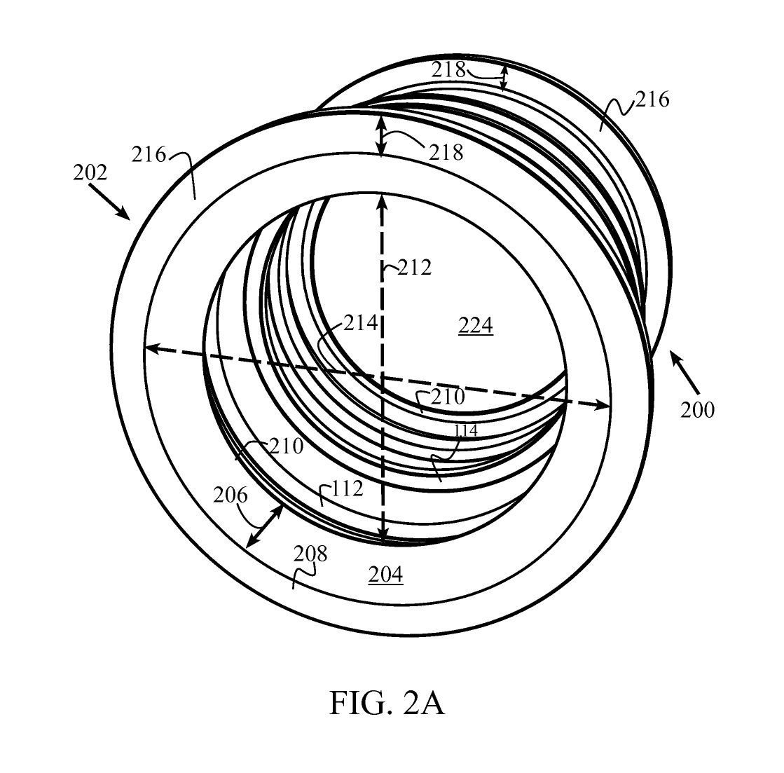

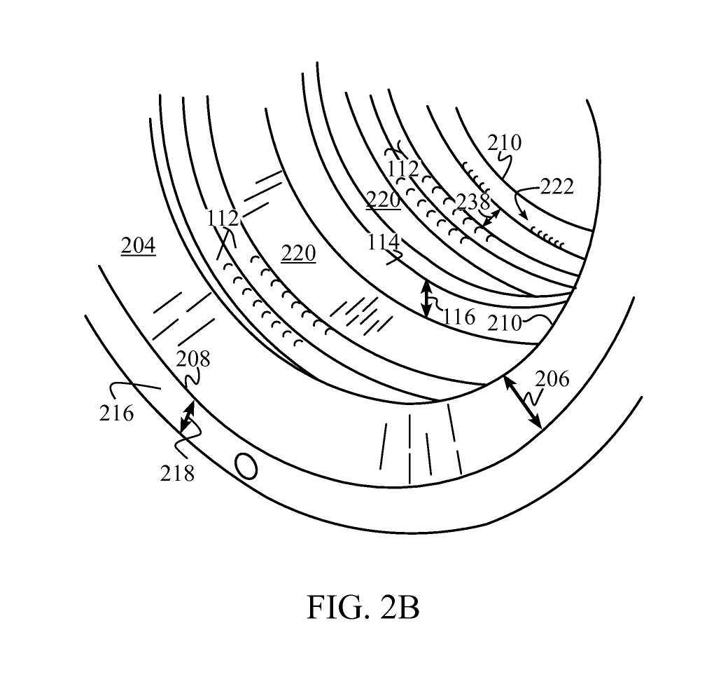

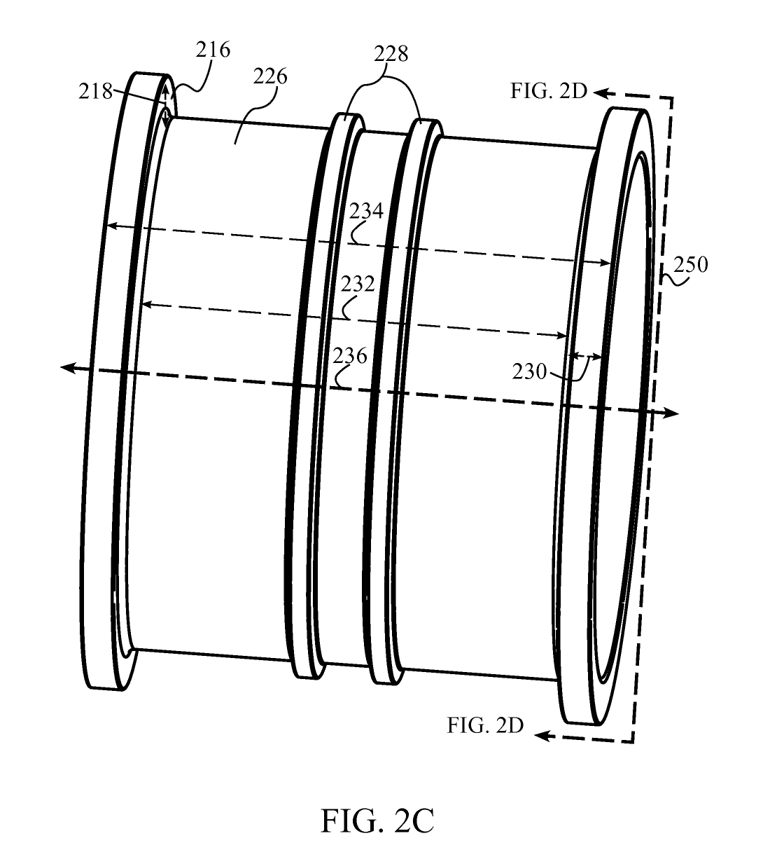

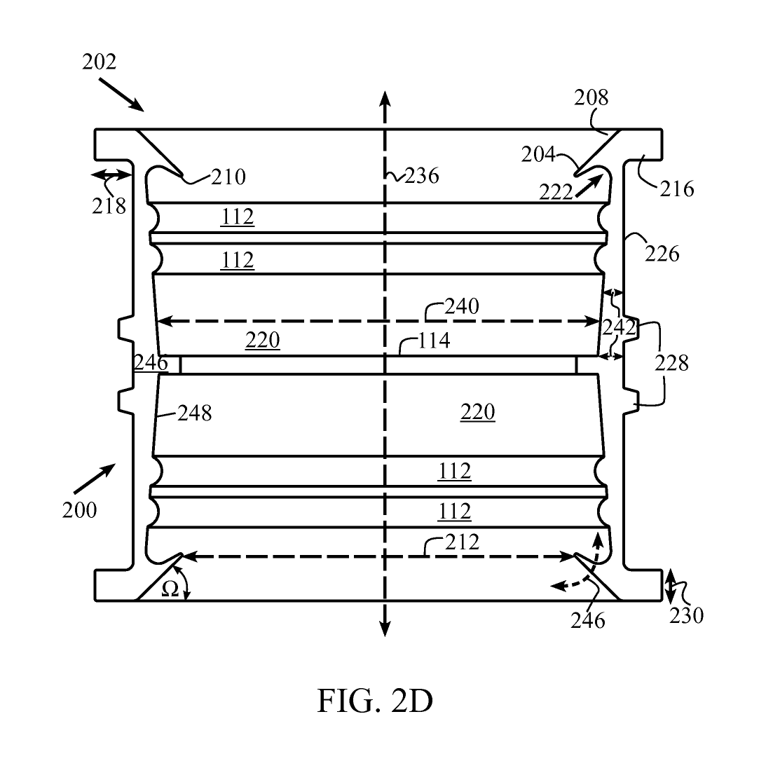

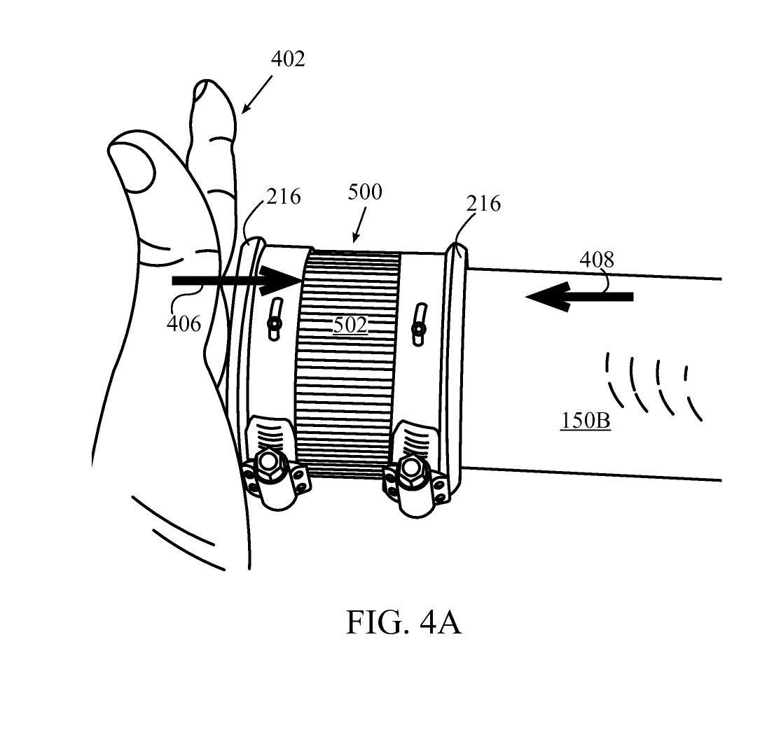

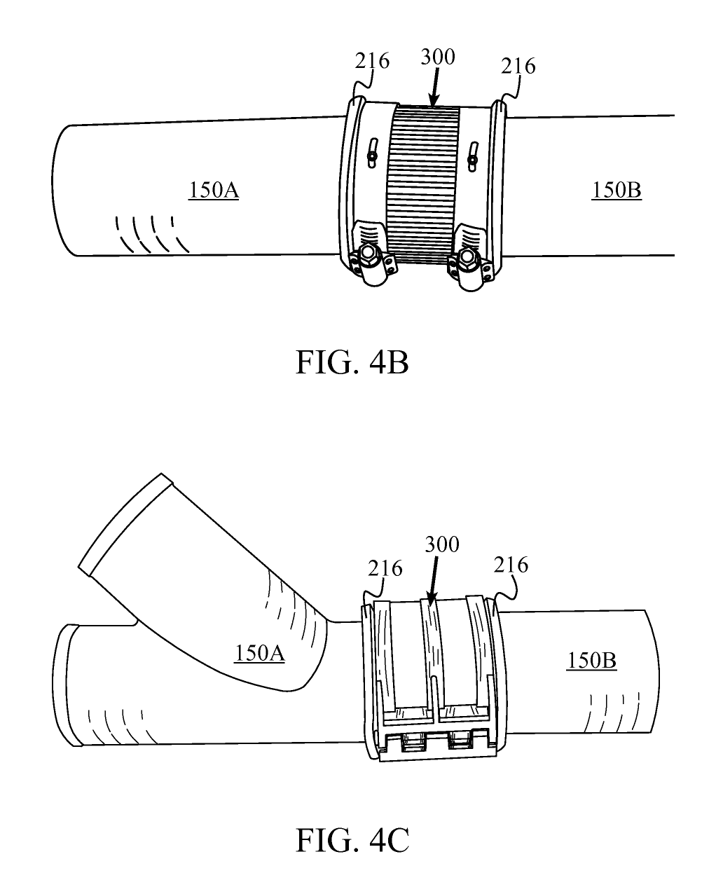

The present invention provides an improved gasket that is easier to install and capable of speeding up installation of projects where pipes (or pipes and pipe fittings) need to be joined through the use of a coupling device and a gasket therein. FIGS. 2A to 2D are non-limiting exemplary illustrations of the various views of a gasket in accordance with the present invention. As illustrated, the present invention provides a gasket 200 with an axial length 234 (FIG. 2C), comprising a chamfered opening 202 for facilitating insertion of an object (e.g., pipe segments 150A and 150B, illustrated in FIGS. 4B and 4C) within the gasket 200.

The chamfered opening 202 is comprised of a flexible flap 204 that extends from a distal edge 208 of a cavity 224 of the gasket 200, forming a chamfered edge. The flexible flap 204 is comprised of a radially symmetric surface that has a radial span 206 that uniformly converges inwardly, sloping at an angle Ω from the distal edge 208 into the cavity 224, toward a central longitudinal axis 236 of the gasket 200.

As is best illustrated in FIG. 2D (which is a cross-sectional view of FIG. 2C, with the plane upon which this sectional view is taken indicated on FIG. 2C by a broken line 250), the chamfered edge (or flap 204) has a thicker mass at or near the distal edge 208 for structural integrity that adds strength for maintaining the forms of the distal edge 208 and the chamfered edge 204 for proper seal and for withstanding bending pressures during insertion of the object into the cavity 224 of the gasket 200. Accordingly, the chamfered edge 204 progressively and gradually decreases in thickness ending at a tip 210 to form a flexible lip that functions as a vane that facilitates movement along a reciprocating path indicated by the arrow 246 of the chamfered edge 204 and insertion of the object into the cavity 224 of the gasket 200, but obstructs and hinders the extraction of the object and substantially seals material from existing the cavity 224. That is, the chamfered edge 204 includes a hook-formed inner bottom surface 222 that prevents potential or possible leakage of material that may leak at the adjoining or junction of pipe segments at the pipe stop 114.

As best illustrated in FIGS. 2A and 2D, the chamfered edge 204 has an inner diameter 212 (measured from tip 210) defining the opening into the cavity 224 of the gasket 200. The chamfered edge 204 also includes an outer diameter 214 with a span that is sized longer than a diameter of the object (e.g., pipe) to be inserted into the cavity 224 of the gasket 200. It should be noted that the diameter of the object to be inserted is preferably larger than the inner diameter 212 of the chamfered opening 204.

In addition to a wider diameter 214 of the chamfered edge 204, the cavity 224 of gasket 100 has a diameter 240 that decreases along the central longitudinal axis 236 from the chamfered opening 202 to a point (a non-limiting example of which is stop 114) within the cavity 224, further facilitating ease of insertion of an object. The variation of the inner cavity diameter 240 is due to variations in the thickness 242 of the walls 246 of the gasket 200. That is, as best illustrated in FIG. 2D, the walls 246 decrease in thickness 242 along the central longitudinal axis 236 from a point within the cavity 224 to the chamfered opening 202 (from inner side 248 of the wall 246), but remain substantially uniform at the outside.

During operation, a distal end 156A of a pipe segments 150A is positioned adjacent the chamfered opening 202, where the exterior diameter 152 of the pipe segment 150A is smaller than the chamfered opening diameter 214 of the chamfered opening 202. This enables easy alignment and orientation of the pipe segment distal end 156A adjacent the chamfered opening 202. The chamfered edge 204 of the chamfered opening 202 guides the pipe segment during the application of a force on the pipe segment and the gasket 200 (FIG. 4A) to push the pipe segment 150A into the cavity 224 of the gasket 200. The guidance of the chamfered edge 204 prevents the distal end 156A of the pipe segment 150A from unintentionally veering at an angle away from the opening of the gasket during the application of the force for insertion. The flexible tip 210 of the chamfered edge 204 flexes along the reciprocating path in the direction indicated by the arrow 246 to further ease and guide the insertion of the pipe segment distal end 156A into the cavity 224, and the progressively varying diameter 240 of the cavity 224 (which is wider or has a longer span at the distal ends of the cavity 224) further facilitates easier insertion of the pipe segment.

The chamfered opening 202 further includes a flange 216 with a height 218 and thickness 230 that protrudes from the distal edge of the cavity 224. The flange 216 extends radially, outwardly diverging away from the central longitudinal axis 236 of the gasket 200. It should be noted that the flange may be positioned at a distal end of the gasket that does not include a chamfered opening. In other words, the chamfered opening may be positioned at a first distal end of the gasket 200 and the flange positioned at a (opposite) second distal end thereof.

One of the functions of the flange 216 is to aid in protecting the hands 402 of users (FIG. 4A) from being cut by the sharp edges 510 of a typical conventional shield 502 (or the claps) of a conventional coupling device 500 when installing the gasket 200 and the coupling device 500. The user's hand 402 may press against the flanges 216 of an already assembled coupling device 500 and gasket 200 combination, and push the combined unit at the direction indicated by the arrow 406, while at the same time, pushing the pipe segment 150B with the other hand at the direction indicated by the arrow 408. The flanges 216 protect the hand 402 against the sharp edges of the shield 502 of the coupling device 500, and enable the combined and assembled coupling device and the gasket to be together coupled with a pipe segment.

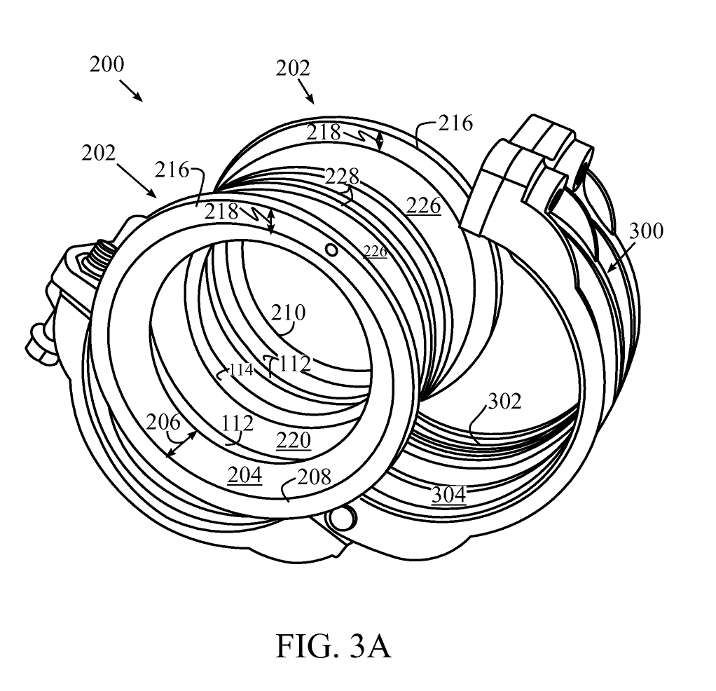

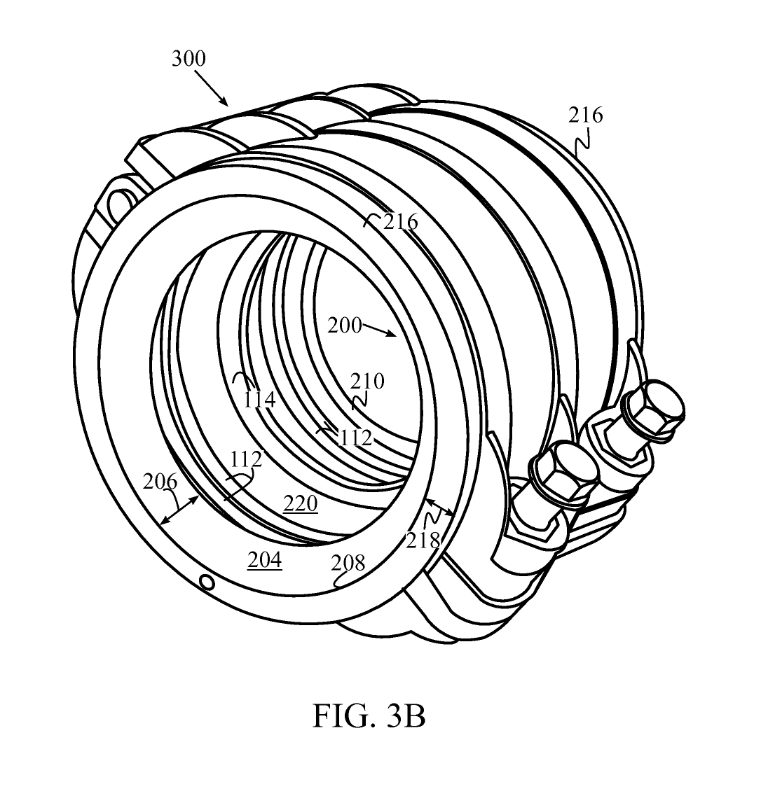

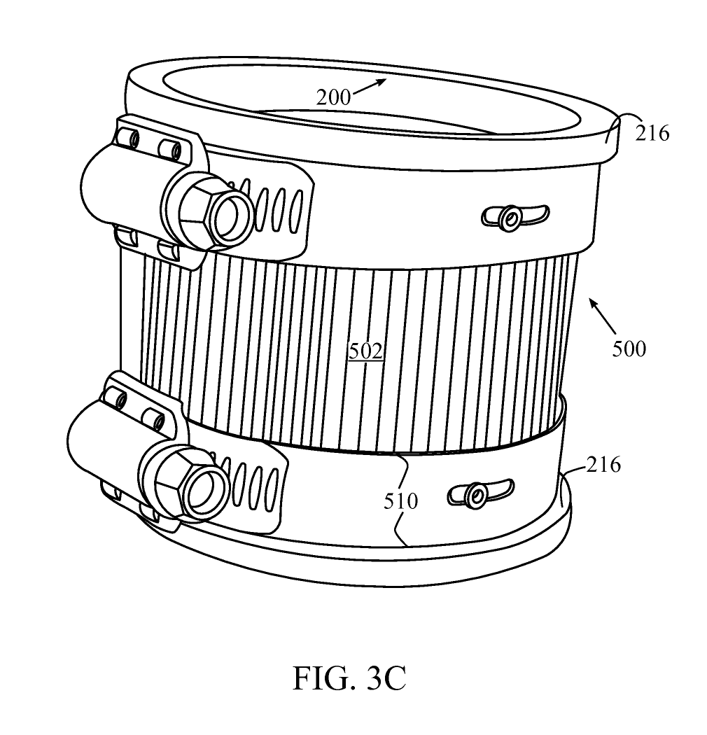

As further illustrated in FIGS. 3B and 3C, if two flanges are used, that is, if the gasket includes two flanges at its distal ends, the coupling devices (300 or 500) may be maintained in position (indicated by the span 232 of FIG. 2C) and not move along the body of the gasket 200 (during and after installation). That is, the flanges would “contain” the coupling devices 300 and 500 (as illustrated in FIGS. 3B and 3C) before, during, and after installation of the entire unit (coupling device and the gasket 200). In other words, the coupling device would not slip off of the gasket during pushing operation of the hand when installing or being coupled with the pipe segment, and would remain in between the flanges at 232 (FIG. 2C).

As best illustrated in FIGS. 2C and 2D, the outer surface 226 of the gasket 200 may optionally include one or more radially extending protuberances 228, transverse the longitudinal axis 236 of the gasket 200, forming outer surface rings. The position of the rings 228 along the outer surface 226 and in relation to one another may be varied. The rings function to substantially equalize (or balance) the contact and pressure points on the gasket outer surface 226 when secured by the coupling device 300 (FIG. 3C), which includes complementary grooves 304 and protuberances 302. That is, when secured, the grooves 304 of the coupling device accommodate the protuberances 228 of the gasket 200, and the protuberances 302 of the coupling device 300 are accommodated on the outer surface 226 of the gasket 200. It should be noted that any coupling device with different types or configurations of grooves or embossments might be use. Accordingly, the rings 228 of the gasket 200 may be modified (e.g., repositioned or varied in dimensions) and specifically configured and particularly adapted to correspondingly match with a set of complementary grooves (or flat surfaces) of a commensurate coupling device to substantially equalize (or balance) the contact and pressure points on the gasket outer surface 226 when the coupling device 300 is secured on top of the gasket 100.

As indicated above, the rings 228 are optional, but if used with other types of coupling devices 500 (FIG. 3C), they would be beneficial in that if positioned proximal the center of the gasket, they would be above the distal ends of the pipe segments and hence, when the coupling device 500 is secured on the gasket 200 and tightened, the rings 228 will provided added pressure onto the distal ends of the pipe segments for a more secure grip. That is, as best illustrated in FIGS. 2D, the outer surface 226 between the rings is where the two distal ends of the pipe segments are adjoined at stop 114 and therefore, the adjoined section may be held together by greater pressure from the raised rings 228 as a result of the tightening of the coupling device 500 on the ring surfaces.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A gasket, comprising:
a chamfered opening for facilitating insertion of a pipe within the gasket;
the chamfered opening is comprised of:
a flexible flap that extends from a distal edge of a cavity, forming a chamfered edge.

2. The gasket as set forth in claim 1, wherein:
the flexible flap is comprised of a radially symmetric surface that radially spans and uniformly converges inwardly, sloping at an angle into the cavity, toward a central longitudinal axis of the gasket.

3. The gasket as set forth in claim 1, wherein:
the chamfered opening further includes a hook-formed inner bottom surface.

4. The gasket as set forth in claim 1, wherein:
the chamfered edge has a thicker mass at the distal edge for structural integrity that adds strength for maintaining the distal edge and the chamfered side forms for proper seal and for withstanding bending pressures during insertion of the pipe into the cavity of the gasket.

5. The gasket as set forth in claim 1, wherein:
the chamfered edge progressively and gradually decreases in thickness ending at a tip to form a flexible lip that functions as a vane that facilitates movement and insertion of the pipe into the cavity of the gasket, but obstructs and hinders the extraction of the pipe and substantially seals liquid material from exiting the cavity.

6. The gasket as set forth in claim 1, wherein:
the chamfered edge has an inner diameter defining the opening into the cavity of the gasket, and an outer diameter with a span that is sized longer than a diameter of the pipe inserted into the cavity of the gasket.

7. The gasket as set forth in claim 1, wherein:
the cavity has a diameter that decreases along the central longitudinal axis from the chamfered opening to a point within the cavity;

8. The gasket as set forth in claim 1, further comprising:
a flange that protrudes from the distal edge.

9. The gasket as set forth in claim 8, wherein:
the flange extends radially, outwardly diverging away from the central longitudinal axis of the gasket.

10. The gasket as set forth in claim 1, further comprising:
a flange that protrudes from another distal edge of the cavity of the gasket.

11. The gasket as set forth in claim 10, wherein:
the flange extends radially, outwardly diverging away from the central longitudinal axis of the gasket.

12. The gasket as set forth in claim 1, further comprising:
a second chamfered opening.

13. The gasket as set forth in claim 12, further comprising:
a flange that protrudes from the distal edge.

14. A gasket, comprising:
a chamfered opening for facilitating insertion of a pipe within the gasket;
the chamfered opening is comprised of a radially symmetric sloping surface that radially extends from a distal edge and uniformly converges inwardly at an angle into a cavity of the gasket toward a central longitudinal axis of the gasket, forming a chamfered edge; and
a radial flange that protrudes from the distal edge and extends outwardly diverging away from the central longitudinal axis of the gasket.

15. The gasket as set forth in claim 14, further comprising:
a second chamfered opening and a second radial flange at another distal edge of the cavity of the gasket.

16. A gasket, comprising:
a first chamfered opening and a second chamfered opening for facilitating insertion of pipes within the gasket;
the chamfered openings are comprised of a radially symmetric sloping surface that radially extends from distal edges and uniformly converges inwardly at an angle into a cavity of the gasket toward a central longitudinal axis of the gasket, forming respective first and second chamfered edges; and
a first radial flange and a second radial flange that protrude from the distal edges and extend outwardly diverging away from the central longitudinal axis of the gasket.

17. A gasket, comprising:
an opening and a chamfered opening for facilitating insertion of pipes within the gasket;
the chamfered opening is comprised of a radially symmetric sloping surface that radially extends from a distal edge and uniformly converges inwardly into a cavity of the gasket toward a central longitudinal axis of the gasket, forming a chamfered edge; and
the cavity has a diameter that decreases along the central longitudinal axis from the opening and the chamfered opening to a point within the cavity.

18. The gasket as set forth in claim 17, further comprising:
the opening is a second chamfered opening.

19. A gasket, comprising:
cylindrical body with a cavity;
a first chamfered opening at a first end of the cylindrical body and a second chamfered opening at a second end of the cylindrical body;
the first and the second chamfered openings are comprised of a radially symmetric sloping surface that radially extend from distal edges of the first and second end of the cylindrical body and uniformly converge inwardly into a cavity of the gasket toward a central longitudinal axis of the gasket, forming a respective first and second chamfered edge;
the cavity has a diameter that decreases along the central longitudinal axis from the first and second chamfered openings to a point within the cavity, with the exterior diameter of the cylindrical body being uniform; and
a first radial flange and a second radial flange that protrude from the distal edges of the first and second end of the cylindrical body and extend outwardly diverging away from the central longitudinal axis of the gasket.

20. The gasket as set forth in claim 19, wherein:
the outer surface of the cylindrical body includes one or more radially extending protuberances, transverse the longitudinal axis of the gasket, forming outer surface rings.

21. The gasket as set forth in claim 19, wherein:
an inner surface of the cavity includes a radially extending wall with a height that forms a flat ring with a substantially flat surface that radially protrudes from the inner surface of the cylindrical body of the gasket for preventing excess insertion of a piper into the cavity, and for providing a sealant at a junction between two distal edge surfaces of pipes inserted via the first and second chamfered openings that are adjoined inside the cavity of the gasket, with the two distal edge surfaces of pipes abutting against sides of the radially extending wall.

22. The gasket as set forth in claim 19, wherein:
an inner surface of the cavity includes a plurality radially extending protuberances on the inner surface of the gasket, transverse the longitudinal axis of the gasket; and
the radially extending protuberances are positioned near the first and second chamfered openings a distance away from the outer edge rim of the first and second ends for preventing movement of the pipe inserted within the cavity segment and for resisting leakage during operation.

23. A pipe coupling device, comprising:
a gasket that includes:
cylindrical body with a cavity;
a first chamfered opening at a first end of the cylindrical body and a second chamfered opening at a second end of the cylindrical body;
the first and the second chamfered openings are comprised of a radially symmetric sloping surface that radially extend from a distal edge of the first and second end of the cylindrical body and uniformly converge inwardly at an angle into a cavity of the gasket toward a central longitudinal axis of the gasket, forming a respective first and second chamfered edge;
the cavity has a diameter that decreases along the central longitudinal axis from the first and second chamfered openings to a point within the cavity;
a first and a second radial flanges that protrude from the distal edge of the first and second end of the cylindrical body and extend outwardly diverging away from the central longitudinal axis of the gasket; and
a pipe coupler that is secured in between the first and the second flanges.
